(19) United States
(12) Patent Application Publication
(10) Pub. No.: US 2006/0272987 A1
(43) Pub. Date: Dec. 7, 2006

(54) Transfer mechanism and transfer method of semiconductor package

(76) Inventors: Hyun-Gyun Jung, Bupyeong-Gu (KR); Seok-Bae Kim, Bupyeong-Gu (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/473,626

(22) Filed: Jun. 22, 2006

Related U.S. Application Data
(63) Continuation of application No. PCT/KR04/03339, filed on Dec. 17, 2004.

(30) Foreign Application Priority Data
Dec. 22, 2003 (KR) 10-2003-0094757

(51) Int. Cl. B07C 5/02

(52) U.S. Cl. 209/538

(57) ABSTRACT

A semiconductor package transfer mechanism and a semiconductor package transfer method are disclosed. The semiconductor package transfer mechanism includes a plurality of pickup units, which are movable along a shaft extending in one direction and operated individually from each other, and a vision inspection apparatus installed across a moving route of the pickup unit in order to inspect defects of the semiconductor packages transferred thereto by means of the pickup units. The pickup units pick up a predetermined amount of semiconductor packages adapted for one-time photographing capacity of the vision inspection apparatus and instantly transfer the semiconductor packages to the vision inspection apparatus. Time delay and waiting time for the semiconductor packages are significantly reduced during the process of the handler system, thereby significantly improving the transfer efficiency and vision inspection efficiency.

### CROSS-REFERENCE TO RELATED APPLICATIONS

This application is a continuation application under 35 U.S.C. § 365 (c) claiming the benefit of the filing date of PCT Application No. PCT/KR2004/003339 designating the United States, filed Dec. 17, 2004. The PCT Application was published in English as WO 2005/062375 on Jul. 7, 2005, and claims the benefit of the earlier filing date of Korean Patent Application No. 10-2003-0094757, filed Dec. 22, 2003. The contents of the Korean Patent Application No. 10-2003-0094757 and the International Application No. PCT/KR2004/003339 including its publication are incorporated herein by reference in their entirety.

### BACKGROUND OF THE INVENTION

1. Field of the Invention

The present invention relates to a transfer mechanism and a transfer method for semiconductor packages, and more particularly to a transfer mechanism and a transfer method for semiconductor packages, in which a predetermined amount of semiconductor packages adapted for one-time photographing capacity of a vision inspection apparatus is picked up by a pickup unit and instantly transferred to the vision inspection apparatus.

2. Description of the Related Technology

Generally, in order to fabricate semiconductor packages, semiconductor chips having highly integrated circuits, such as transistors and capacitors, are attached to a semiconductor substrate made from silicon and an upper surface of the semiconductor substrate is molded with resin. After the molding process, a ball grid array (BGA) playing a role of a lead frame is bonded to a lower surface of the semiconductor substrate such that the BGA is electrically communicated with the semiconductor chips. Then, a sawing process is carried out with respect to the semiconductor substrate by means of a sawing machine, thereby obtaining an individual semiconductor package. The above processes are generally called a “singulation process”. After the singulation process has been finished, a washing process and a drying process have been carried out with respect to the semiconductor package so as to remove impurities from a surface of the semiconductor package. Then, an inspection process is carried out with respect to each semiconductor package in order to check defects of the semiconductor packages.

That is, after the sawing, washing and drying processes have been finished, the semiconductor package is transferred to a vision inspection apparatus by means of a semiconductor package transfer unit.

### SUMMARY OF CERTAIN INVENTIVE ASPECTS

One aspect of the invention provides a semiconductor package transfer system comprising: a plurality of pickup units operable independently of one another, each of the pickup units being configured to move along a respective one of a plurality of first paths; and a vision inspection apparatus movable along a second path, the second path intersecting with the plurality of first paths, the vision inspection apparatus being configured to simultaneously inspect a predetermined number of workpieces arranged in a predetermined pattern, the predetermined number being substantially the maximum inspection capacity of the vision inspection apparatus, wherein each of the pickup units is configured to transport the predetermined number of workpieces in the predetermined pattern to and from the vision inspection apparatus.

The predetermined pattern may comprise a matrix pattern comprising a plurality of rows and a plurality of columns, and each of the rows may comprise a first number of workpieces, and each of the columns may comprise a second number of workpieces. The first number may be the same as the second number. The first number may be different from the second number. The predetermined pattern may further comprise another row and/or another column. The other row may have a third number of workpieces, and the other column may have a fourth number of workpieces. The third number may be different from the first number, and the fourth number may be different from the second number.

The plurality of first paths may extend substantially parallel to one another in a first direction, and the second path may extend in a second direction substantially perpendicular to the first direction.

The vision inspection apparatus may be configured to inspect first workpieces when positioned at a first intersection between the second path and one of the plurality of first paths. The vision inspection apparatus may be configured to move to a second intersection between the second path and another of the plurality of first paths after inspecting the first workpieces, and the vision inspection apparatus may configured to inspect second workpieces at the second intersection. One of the pickup units may be configured to transport the second workpieces to the second intersection. The one of the pickup units may be configured to transport the second workpieces to the second intersection such that the workpieces are ready for inspection before the inspection apparatus reaches the second intersection.

The system may further comprise at least one first transfer unit and at least one second transfer unit, wherein the at least one first transfer unit is configured to transport the workpieces from an immediately previous processing location to a position which allows at least one of the pickup units to pick up the workpieces, and wherein the at least one second transfer unit is configured to transport the workpieces to an immediately subsequent processing location from a position which allows at least one of the pickup units to unload the workpieces. The at least one first transfer unit may be configured to travel along a third path and the third path may extend substantially parallel to the second path and substantially perpendicular to the plurality of first paths. The third path may intersect with the plurality of first paths. The at least one second transfer unit may be configured to travel along a fourth path. The fourth path may extend substantially parallel to the second path and substantially perpendicular to the plurality of first paths, and the fourth path may intersect with the plurality of first paths.

The third path may be positioned between the second path and the fourth path. The second path may be positioned between the third path and the fourth path. The fourth path may be positioned between the second path and the third path.

The system may comprise at least two shafts extending parallel to one another in one direction and at least two first transfer units, wherein each of the first transfer units comprises a moving frame movable along one of the shafts, and a turntable including a loading groove part on which the workpieces are loaded and an extra space part, wherein the loading groove part and the extra space part are alternately aligned, and wherein the first transfer units are operated independently of one another so as to alternately transfer the workpieces to and from the vision inspection apparatus. The at least one first transfer unit may be configured to carry a multiple of the predetermined number of workpieces.

Another aspect of the invention provides a method of transferring semiconductor packages. The method comprises: providing a vision inspection apparatus configured to simultaneously inspect a predetermined number of workpieces arranged in a predetermined pattern, the predetermined number being substantially the maximum inspection capacity of the vision inspection device; transporting the predetermined number of first workpieces in the predetermined pattern to a first position; and moving the vision inspection apparatus to the first position; and simultaneously inspecting the predetermined number of first workpieces using the vision inspection device.

The method may further comprise: transporting the predetermined number of second workpieces in the predetermined pattern to a second position; moving the vision inspection apparatus to the second position after inspecting the first workpieces; and simultaneously inspecting the predetermined number of second workpieces at the second position using the vision inspection device.

Another aspect of the invention provides a transfer mechanism and a transfer method for semiconductor packages, in which a pickup unit is provided to instantly transfer the semiconductor packages to a vision inspection apparatus by picking up a predetermined amount of semiconductor packages adapted for one-time photographing capacity of the vision inspection apparatus. The vision inspection apparatus is provided such that it can move in a direction across a moving route of a semiconductor package pickup unit, thereby maximizing the vision inspection efficiency for the semiconductor packages.

Another aspect of the invention provides a semiconductor package transfer mechanism comprising: a plurality of pickup units, which are movable along a shaft extending in one direction and operated individually from each other; and a vision inspection apparatus installed across a moving route of the pickup unit in order to inspect defects of the semiconductor packages transferred thereto by means of the pickup units, wherein the pickup units pick up a predetermined amount of semiconductor packages adapted for one-time photographing capacity of the vision inspection apparatus and instantly transfer the semiconductor packages to the vision inspection apparatus.

The pickup units may pick up and transfer the semiconductor packages aligned in a matrix pattern of multiple columns and multiple rows (m×m, wherein m≧2). The vision inspection apparatus may be controlled in such a manner that the vision inspection apparatus is operated in relation to operations of the pickup units, and the vision inspection apparatus moves into a photographing area allowing the vision inspection apparatus to photograph all semiconductor packages held by the pickup units, thereby inspecting defects of all semiconductor packages.

The vision inspection apparatus may be installed between a semiconductor package transfer unit, which transfers the semiconductor packages to the vision inspection apparatus after a drying process for the semiconductor packages has been finished, and a semiconductor package tray mounting unit, on which the semiconductor packages are mounted after a vision inspection process for the semiconductor packages has been finished.

The semiconductor package transfer mechanism may further include a pair of semiconductor package transfer units. Each semiconductor package transfer unit may include a moving frame, which is movable along a shaft extending in one direction, and a turntable including a loading groove part on which the semiconductor packages are loaded and an extra space part, the loading groove part and the extra space part are alternately aligned, and the semiconductor package transfer units are operated individually from each other so as to alternately transfer the semiconductor packages to the vision inspection apparatus.

Yet another aspect of the invention provides a method of transferring semiconductor packages. The method comprises the steps of: primarily transferring the semiconductor packages to a plurality of pickup units, which are operated individually from each other, after washing and drying processes for the semiconductor packages have been finished; secondarily transferring the semiconductor packages to a vision inspection apparatus by means of one of pickup units just after the pickup unit picks up a predetermined amount of the semiconductor packages adapted for one-time photographing capacity of the vision inspection apparatus; and performing vision inspection with respect to the semiconductor packages held by the pickup unit by moving the vision inspection apparatus towards the pickup unit moving towards the vision inspection apparatus while holding the semiconductor packages.

The vision inspection apparatus may perform the vision inspection with respect to the semiconductor packages after the semiconductor packages held by the pickup unit enter a vision inspection area allowing the vision inspection apparatus to simultaneously photograph the semiconductor packages at a time. When the semiconductor packages are secondarily transferred, the pickup unit may pick up the semiconductor packages aligned in a matrix pattern of multiple columns and multiple rows (m×m, wherein m≧2) and may instantly transfer the semiconductor packages to the inspection apparatus.

### BRIEF DESCRIPTION OF THE DRAWINGS

The foregoing and other objects, features and advantages of the invention will become more apparent from the following detailed description when taken in conjunction with the accompanying drawings in which:

FIG. 1 is a plan view schematically illustrating a semiconductor package transfer mechanism;

FIG. 2 is a plan view schematically illustrating a semiconductor package transfer mechanism according to one embodiment;

FIG. 3 is a view illustrating semiconductor packages transferred to a vision inspection apparatus by a pickup unit of a semiconductor package transfer mechanism shown in FIG. 2;

FIG. 4 is a perspective view illustrating package transfer units of a semiconductor package transfer mechanism shown in FIG. 2 according to one embodiment;

FIG. 5 is a perspective view illustrating a package transfer unit of a semiconductor package transfer mechanism shown in FIG. 2 according to another embodiment;

FIGS. 6a to 6e are plan views illustrating a transfer procedure for the semiconductor packages by means of a semiconductor package transfer mechanism shown in FIG. 2;

FIG. 7 is a plan view schematically illustrating a semiconductor package transfer mechanism according to another embodiment; and

FIG. 8 is a plan view schematically illustrating a semiconductor package transfer mechanism according to another embodiment.

### DETAILED DESCRIPTION OF CERTAIN INVENTIVE EMBODIMENTS

Reference will now be made in detail to embodiments of the invention with reference to accompanying drawings. In the following description, a detailed description of known functions and configurations incorporated herein will be omitted.

A semiconductor package transfer mechanism is disclosed in Korean Patent Laid-Open Publication No. 2002-0049954, which has been filed by the applicant of the present application, with the title of “Handler System For Sawing Semiconductor Devices.”

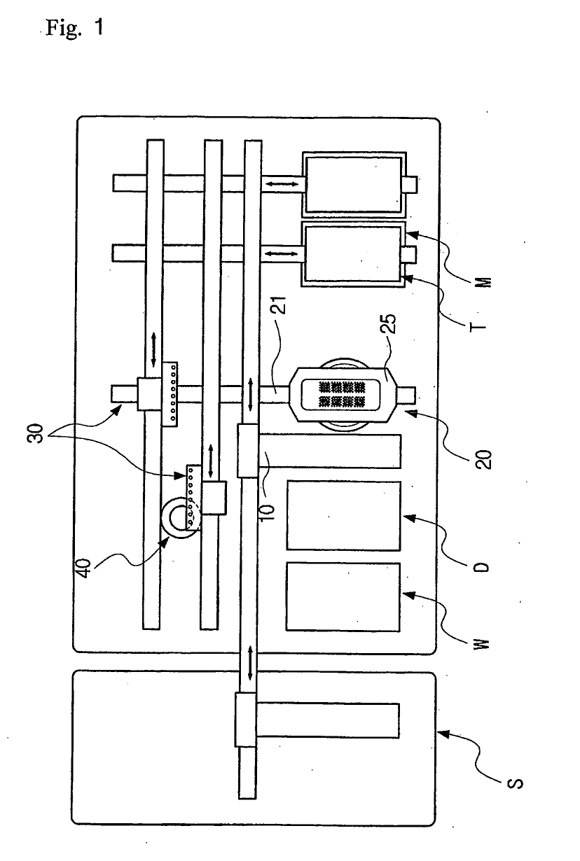

FIG. 1 shows the semiconductor package transfer mechanism. FIG. 1 is a plan view schematically showing the semiconductor package transfer mechanism. In FIG. 1, reference characters S, W and D represent a sawing machine, a washing machine, and a dry machine, respectively. In addition, reference character T represents a tray, which is mounted on a tray feeder such that the tray can move along a rail while accommodating semiconductor packages therein, and reference character M represents a tray mounting machine for mounting the tray T thereon. The structure of the handler system including the above elements is disclosed in above Korean Patent Laid-Open Publication No. 2002-0049954 in detail, so the following description will focus on the semiconductor package transfer mechanism.

As shown in FIG. 1, a semiconductor package, which has undergone the sawing, washing and drying processes by means of the sawing machine S, the washing machine W and the dry machine D, is picked up by a package pickup unit 10 and loaded on a turntable 25 of a package transfer unit 20. The semiconductor package loaded on the turntable 25 of the package transfer unit 20 is transferred to a pickup unit including a pair of pickers 30, which are aligned in opposition to each other in order to transfer the semiconductor package to a vision inspection area. When the semiconductor package is transferred to the vision inspection area by means of the pickers 30, a fixed vision inspection apparatus 40 inspects the semiconductor package. The inspected semiconductor package is loaded on the tray T according to the result of the vision inspection for the semiconductor package. Then, the tray T is moved into the tray mounting machine M by means of the tray feeder so that the tray T is mounted on the tray mounting machine M by means of the pickers.

However, according to the semiconductor package transfer mechanism having the above structure, the number of the semiconductor packages transferred to the fixed vision inspection apparatus 40 by means of the pickers 30 may be greater than a predetermined number of semiconductor packages adapted for one-time inspection capacity (that is, one-time photographing capacity) of the fixed vision inspection apparatus 40. In this case, pickup and transfer operations for the semiconductor packages may be delayed. In addition, since the pickers 30 are designed to transfer eight semiconductor packages, respectively, by aligning eight semiconductor packages in a line, the fixed vision inspection apparatus 40 must wait for the semiconductor packages until the pickers 30 have gathered eight semiconductor packages, so the vision inspection for the semiconductor packages is inefficiently delayed.

In addition, the vision inspection for the semiconductor packages is carried out through transferring the semiconductor packages to the fixed vision inspection apparatus 40 by means of the pickers 30 aligned in opposition to each other in order to share the vision inspection apparatus 40 by half-and-half. Accordingly, since the fixed vision inspection apparatus 40 is shared by the pair of pickers 30, only a half of the vision inspection area is utilized when performing the vision inspection for the semiconductor packages in the fixed vision inspection apparatus 40, thereby degrading the vision inspection efficiency.

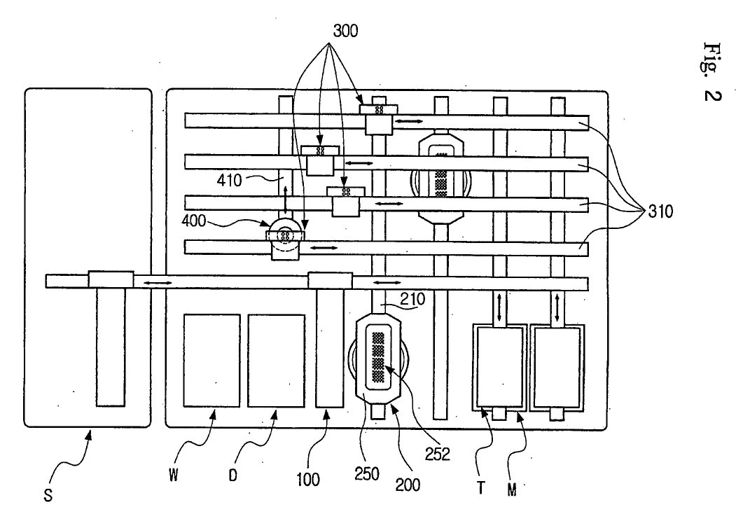

FIG. 2 is a plan view schematically illustrating a semiconductor package transfer mechanism according to an embodiment. In FIG. 2, reference characters S, W and D represent a sawing machine, a washing machine, and a dry machine, respectively. In addition, reference character T represents a tray, which is mounted on a tray feeder such that the tray can move along a rail while accommodating semiconductor packages therein, and reference character M represents a tray mounting machine for mounting the tray T thereon. The following description will focus on the semiconductor package transfer mechanism.

As shown in FIG. 2, the semiconductor package transfer mechanism according to an embodiment includes a pickup unit, a vision inspection apparatus 400 and a package transfer unit 200.

The pickup unit picks up the semiconductor package placed on a turntable 250 of the package transfer unit 200 to transfer the semiconductor package to an upper portion of the vision inspection apparatus 400 and loads the semiconductor package onto the tray T according to the result of the vision inspection for the semiconductor package.

The pickup unit includes four pickers 300 which are operated individually from each other. In other embodiments, the number of the pickers 300 may be varied depending on the design of the mechanism. For example, the pickup unit of FIG. 1 includes a pair of pickers capable of picking up eight semiconductor packages by aligning the semiconductor packages in a line.

Each picker 300 can pick up the semiconductor package loaded on the turntable 250. For instance, the picker 300 includes a picker head (not shown) for sucking the semiconductor package and a vacuum unit (not shown) for supplying suction force to the picker head. In addition, the picker 300 can horizontally move along a second guide rail 310 by means of a horizontal moving unit (not shown). In addition, the picker head can vertically move by means of a vertical moving unit (not shown).

The picker 300 picks up a predetermined number of semiconductor packages adapted for one-time photographing capacity of the vision inspection apparatus 400 and transfers the semiconductor packages to the vision inspection apparatus 400. According to the embodiment, each picker 300 picks up the semiconductor packages such that the semiconductor packages are aligned in the picker 300 in a matrix pattern of two columns and two rows, and instantly transfers the semiconductor packages to the vision inspection apparatus 400.

If one-time photographing capacity of the vision inspection apparatus 400 increases or a photographing area is changed, the structure of the picker 300 is also changed in order to pick up the semiconductor packages according to variation of the one-time photographing capacity of the vision inspection apparatus 400 and the photographing area. That is, the picker 300 can pick up a plurality of semiconductor packages such that the semiconductor packages are aligned in the picker 300 in a matrix pattern of multiple columns and multiple rows (m×n, wherein m≧2 and n≧2, or m×m, wherein m≧2) according to the one-time photographing capacity of the vision inspection apparatus 400.

The vision inspection apparatus 400 is provided to inspect defects of the semiconductor packages. The vision inspection apparatus 400 is movably installed on a guide rail 410 aligned across the moving route of the picker 300. Since the vision inspection apparatus 400 is movably installed on the guide rail 410, the vision inspection apparatus 400 can move into a vision inspection area 420 in order to photograph all semiconductor packages, which are transferred to the vision inspection area 420 by means of the picker 300, thereby inspecting defects of all semiconductor packages.

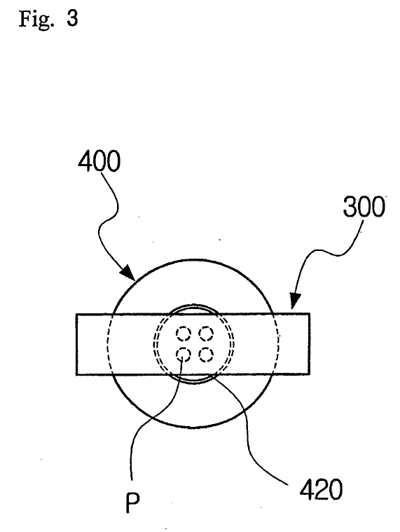

FIG. 3 is a view illustrating the semiconductor packages P transferred to the vision inspection apparatus 400 by the picker 300. FIG. 3 shows the number and the alignment scheme of the semiconductor packages P held by one picker 300 as an example.

As shown in FIG. 3, the picker 300 used for the vision inspection picks up four semiconductor packages P such that the semiconductor packages P are aligned in the picker 300 in a matrix pattern of two columns and two rows (2×2). Accordingly, four semiconductor packages P are aligned above the vision inspection apparatus 400 in the vision inspection area 420.

That is, the picker 300 of the embodiment may transfer the semiconductor packages P aligned in the matrix pattern of two columns and two rows into the vision inspection apparatus 400 in such a manner that the vision inspection apparatus 400 can simultaneously inspect four semiconductor packages P. Thus, the semiconductor package transfer mechanism according to the embodiment can improve the process speed for the vision inspection as compared with the conventional semiconductor package transfer mechanism of FIG. 1, in which the semiconductor packages are transferred in a line (1×n, wherein n≧2) and two semiconductor packages are inspected at a time.

Accordingly, the semiconductor package transfer mechanism of the embodiment can maximally utilize the vision inspection area without wasting the vision inspection area even though it employs the vision inspection apparatus 400 used for the semiconductor package handler system of FIG. 1, so the process speed for the vision inspection can be significantly improved. Therefore, the package processing speed of the semiconductor package handle system for unit per hour (UPH) can be significantly improved.

In addition, according to the embodiment, the picker 300 can instantly transfer the semiconductor packages by picking up a predetermined amount of semiconductor packages adapted for one-time photographing capacity of the vision inspection apparatus 400, time delay does not occur when picking up or transferring the semiconductor packages.

In the meantime, the number of the semiconductor packages P held by the picker 300 is not limited to 4, and the alignment scheme of the semiconductor packages P in the picker 300 is not limited to the matrix pattern of two columns and two rows. In addition, the number and the alignment scheme of the semiconductor packages P inspected in the vision inspection area 420 are not limited to the matrix pattern of two columns and two rows. In general, since the vision inspection area is formed in a circular shape, if the vision inspection apparatus has large capacity, the semiconductor packages can be transferred while being aligned in the picker in the matrix pattern of multiple columns and multiple rows (that is, 3×3, 4×4, etc). In this case, the vision inspection apparatus 400 moves below the picker 300 in order to simultaneously inspect the semiconductor packages. If the photographing area of the vision inspection apparatus 400 is formed in an oval shape, the semiconductor packages can be transferred while being aligned in the picker 300 in a rectangular matrix pattern (that is, m×n, wherein m≧2, n≧2, and m≠n).

In addition, the picker 300 can selectively pick up the semiconductor packages loaded on the turntable 250 according to the operational conditions.

The package transfer unit 200 is provided to transfer the semiconductor packages to a vision inspection section after the drying process for the semiconductor packages has been finished.

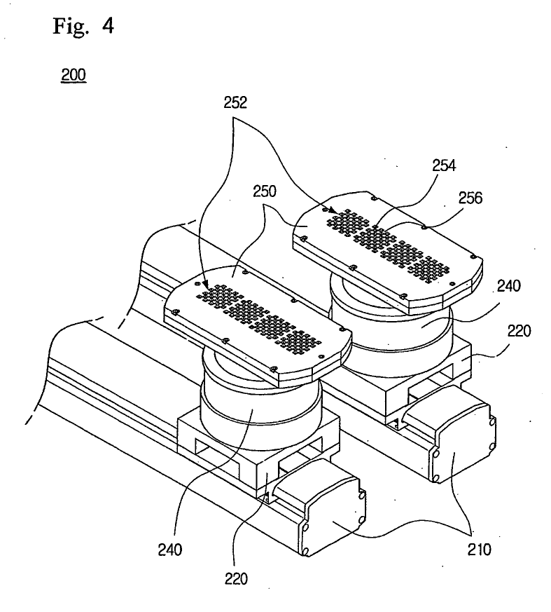

FIG. 4 is a perspective view illustrating package transfer units of a semiconductor package transfer mechanism according to one embodiment. As shown in FIG. 4, the semiconductor package transfer mechanism includes a pair of package transfer units 200, which are operated individually from each other. That is, the package transfer units 200 are controlled such that they can be alternately operated, thereby alternately transferring the semiconductor packages towards the vision inspection apparatus 400 after the drying process for the semiconductor packages has been finished.

The package transfer unit 200 includes a horizontal transfer member 220 movably installed on a first guide rail 210, a servo motor 240 mounted on the horizontal transfer member 220 and a turntable 250 rotatably installed on the servo motor 240 so as to be rotated by means of the servo motor 240.

The horizontal transfer member 220 is horizontally moved by means of a driving unit (not shown). Such a driving unit includes a linear movement system, such as a combination of a screw shaft and a nut member, a rack and pinion assembly, a belt and pulley assembly, or a chain and sprocket wheel assembly, which is generally known in the art.

As shown in FIG. 4, the turntable 250 includes a loading section 252 formed at an upper surface thereof. The loading section 252 has a loading groove part 254, on which the semiconductor package is loaded, and an extra space part 256. The loading groove part 254 and the extra space part 256 are alternatively aligned, thereby forming the loading section 252. In order to effectively load the semiconductor packages of the matrix pattern on the turntable 250 after the drying process has been completed, the loading groove part 254 and the extra space part 256 are formed on each turntable 250 of the pair of the package transfer units 200 symmetrically to each other.

The reason for alternately aligning the loading groove part 254 and the extra space part 256 of the loading section 252 is for precisely loading the semiconductor packages on the turntable 250 without generating an error after the drying process for the semiconductor packages has been finished, and for precisely forming a guide inclination section at an edge of the loading groove part 254. The structure of the loading section 252 is disclosed in detail in Korean Patent Application No. 10-2000-0079284, which has been filed by the applicant of the present application, with the title of “Table Apparatus For Loading Semiconductor Packages Thereon”.

According to the above embodiment, since the pair of the package transfer units 200 are operated individually from each other, the semiconductor packages are instantly transferred to the vision inspection area as soon as the semiconductor packages are loaded on one of the turntables 250. That is, upon receiving the semiconductor packages, the turntable 250 instantly moves towards the vision inspection area without waiting for the other turntable 250 until the semiconductor packages have been loaded on the other turntable 250.

According to another embodiment, a plurality of pairs of turntables including the loading groove part 254, on which the semiconductor package is loaded, and the extra space part 256, which is alternatively aligned with the loading groove part 254, can be provided.

As described above, the semiconductor package transfer mechanism according to the embodiment includes a pair of package transfer units 200, which are operated individually from each other, so that a pair of turntables 250 can alternately transfer the semiconductor packages loaded thereon. In addition, a plurality of pickers 300 are provided to continuously transfer a predetermined amount of semiconductor packages adapted for one-time photographing capacity of the vision inspection apparatus 400. Thus, waiting time for the semiconductor packages can be reduced during the process, thereby improving the process speed of the system.

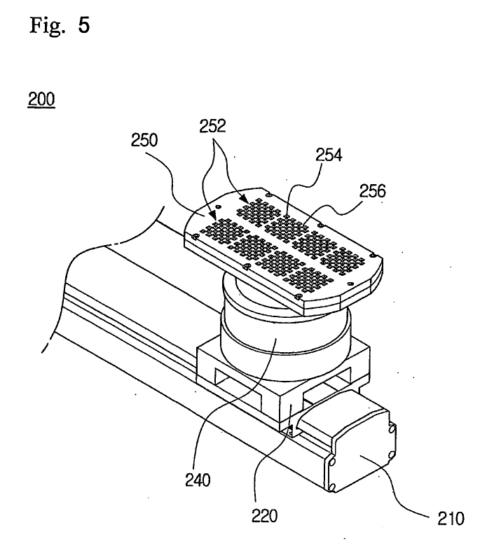

FIG. 5 shows a package transfer unit of a semiconductor package transfer mechanism according to another embodiment. As shown in FIG. 5, the semiconductor package transfer mechanism of the embodiment includes a single package transfer unit 200. Similar to the package transfer unit 200 shown in FIG. 4, the single package transfer unit 200 includes a horizontal transfer member 220 movably installed on the first guide rail 210, a servo motor 240 mounted on the horizontal transfer member 220 and a turntable 250 rotatably installed on the servo motor 240 so as to be rotated by means of the servo motor 240.

However, the turntable 250 shown in FIG. 5 is different from the turntable shown in FIG. 4, in that a pair of loading sections 252 are formed at an upper surface of the turntable 250. Each loading section 252 has a loading groove part 254, on which the semiconductor package is loaded, and an extra space part 256. The loading groove part 254 and the extra space part 256 are alternatively aligned, thereby forming the loading section 252.

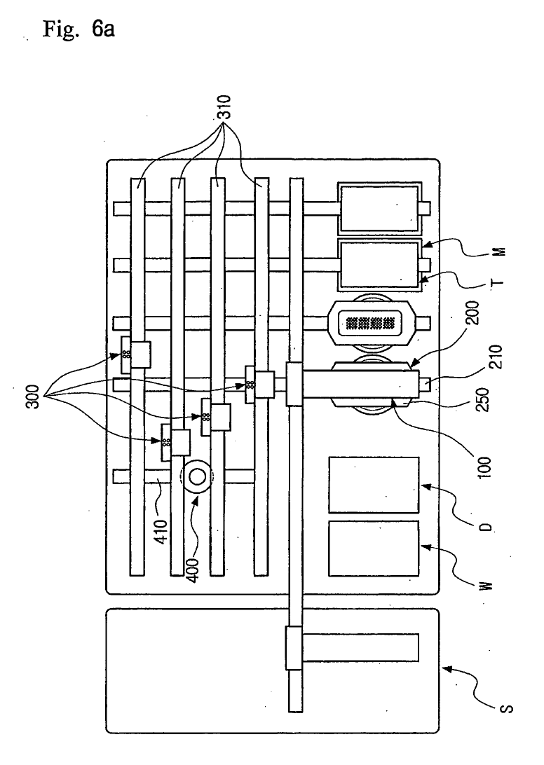

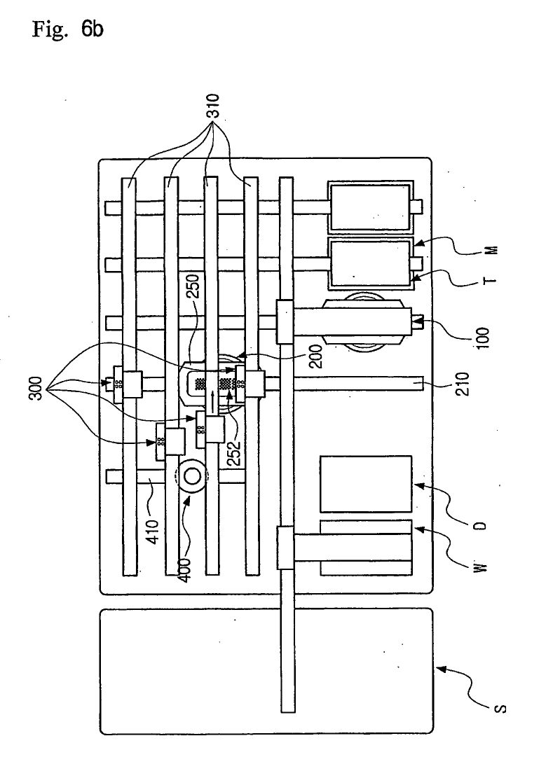

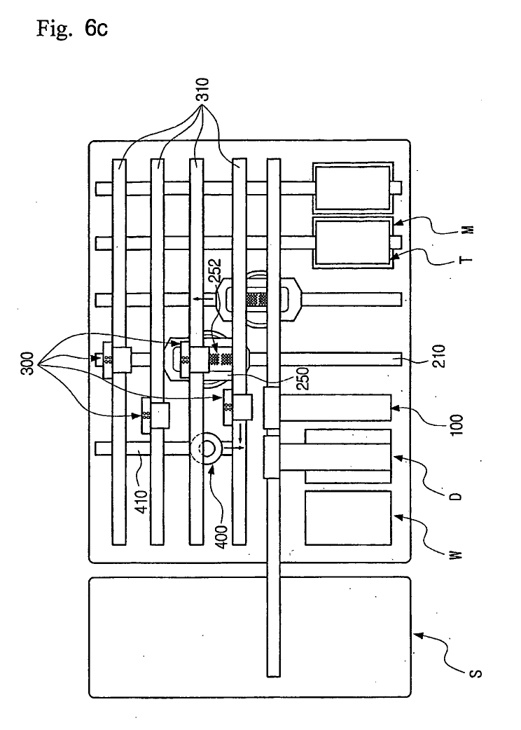

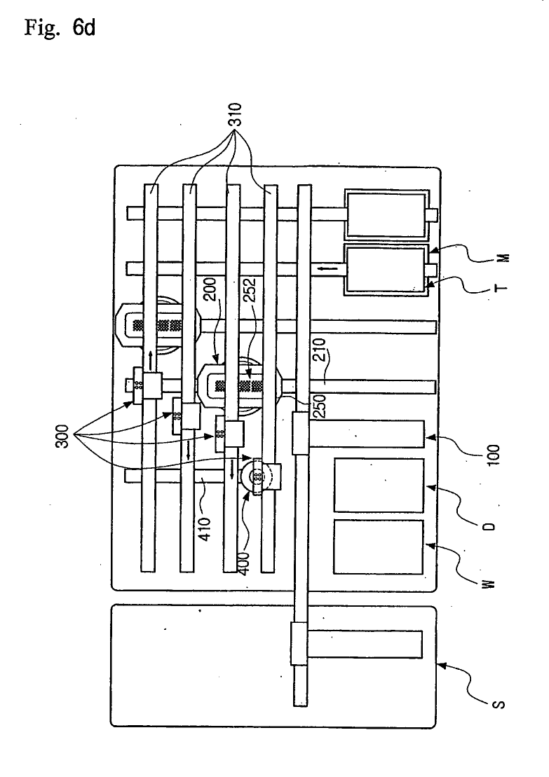

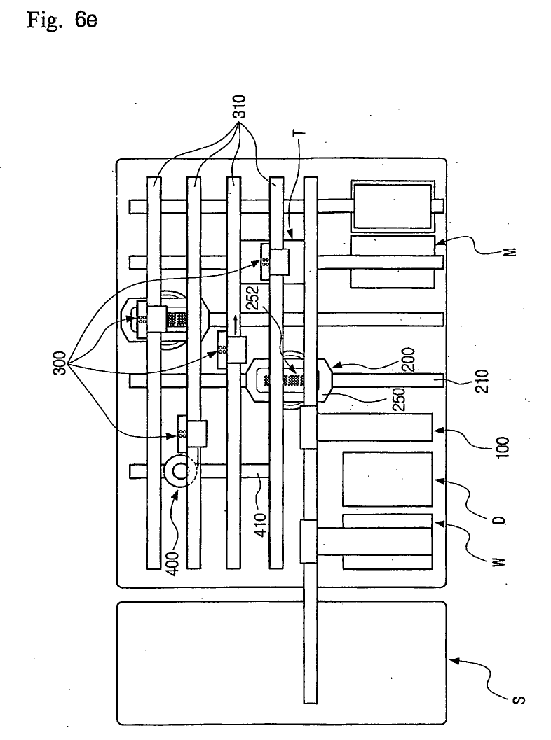

Hereinafter, a method for transferring the semiconductor package according to one embodiment will be described. FIGS. 6a to 6e are plan views illustrating a transfer procedure for the semiconductor packages by means of the semiconductor package transfer mechanism shown in FIG. 2.

The following description will be focused on the semiconductor package transfer procedure without explaining the sawing, washing, and vision inspection processes for the purpose of convenience.

First, after the drying process for the semiconductor packages has been finished, a turntable pickup unit 100 picks up the semiconductor packages from the dry machine D and loads the semiconductor packages on the loading section 252 of one turntable 250 (see, FIG. 6a). The semiconductor packages loaded on the loading section 252 are fixedly adhered to the turntable 250 by means of the vacuum unit. When the semiconductor packages assigned to one turntable 250 have been loaded on the turntable 250, the turntable pickup unit 100 is moved up so as to load the semiconductor packages on the other turntable 250.

At this time, the turntable 250 having the semiconductor packages instantly moves towards the picker 300 along the first guide rail 210 (see, FIG. 6b).

When the turntable 250 reaches the pickup area of the picker 300, the picker 300 picks up the semiconductor packages in such a manner that the semiconductor packages are aligned in the picker 300 in the matrix pattern of two columns and two rows, and instantly moves towards the guide rail 410 (see, FIG. 6c).

At the same time, the vision inspection apparatus 400 moves towards the picker 300 so as to inspect the four semiconductor packages held by the picker 300 at a time when the picker 300 reaches the vision inspection area 420 (see, FIG. 6d).

After the vision inspection process has been finished, the picker 300 moves towards the upper portion of the tray T while holding the semiconductor packages so as to load the semiconductor packages having no defect on the tray T according to the result of the vision inspection for the semiconductor packages. After that, the tray T is moved into the tray mounting machine M by means of the tray feeder and loaded on the tray mounting machine M by means of the pickup unit (see, FIG. 6e).

In addition, while the above procedure is being carried out, the semiconductor packages are loaded on the loading section 252 of the other turntable 250 by means of the turntable pickup unit 100, and the other turntable 250 having the semiconductor packages also moves towards the picker 300 when the semiconductor packages have been loaded on the loading section 252 of the other turntable 250. At this time, the turntable pickup unit 100 moves towards the dry machine D in order to pick up new semiconductor packages.

The above semiconductor package transfer procedure is continuously repeated.

The above semiconductor package transfer procedure may be realized only when the semiconductor package transfer mechanism includes a pair of package transfer units, which are operated individually from each other, as shown in FIG. 4. However, the invention is not limited to the above semiconductor package transfer procedure. For instance, the semiconductor packages can be loaded on a pair of the loading sections 252 of the single turntable 250 as shown in FIG. 5. In this case, the single turntable 250 is controlled such that it moves towards the picker 300 after the semiconductor packages have been loaded on both loading sections 252 of the single turntable 250. That is, the semiconductor package transfer procedure can be variously modified.

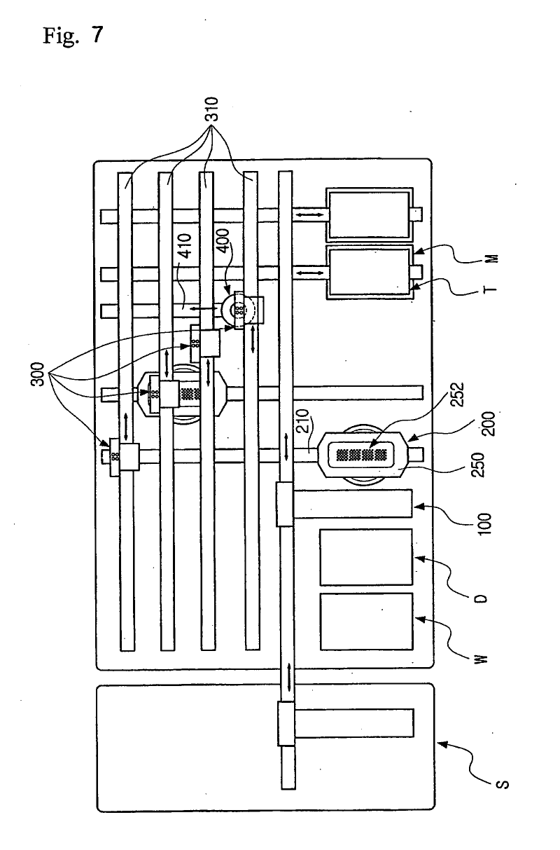

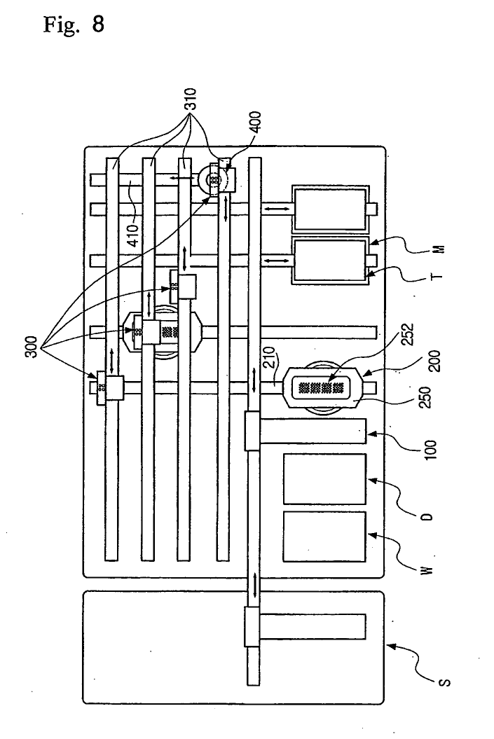

FIGS. 7 and 8 schematically illustrate a semiconductor package transfer mechanism according to other embodiments.

Referring to FIG. 7, the guide rail 410 is installed between the guide rail 210 and a tray guide rail for guiding the tray T. Referring to FIG. 8, the guide rail 410 is installed at an outer side (right side) of the tray guide rail.

According to the above arrangement shown in FIGS. 7 and 8, the vision inspection process is carried out while the picker 300 is being moved towards the tray T, so the transfer time and vision inspection time for the semiconductor packages can be more reduced.

Although the embodiments have been described as if the semiconductor packages are transferred to the picker from the turntable of the package transfer unit, the semiconductor packages (or, strips having a plurality of packages) can be transferred to the picker not only from the turntable of the package transfer unit, but also from any package feeding sources, if one of the pickers can pick up a predetermined amount of the semiconductor packages adapted for one-time photographing capacity of the vision inspection apparatus and the vision inspection apparatus can move towards the picker and inspect the semiconductor package held by the picker.

As can be seen from the foregoing, according to the semiconductor package transfer mechanism and the semiconductor package transfer method of the embodiments, a plurality of pickers, which can be operated individually from each other, may pick up a predetermined amount of the semiconductor packages adapted for one-time photographing capacity of the vision inspection apparatus and instantly transfer the semiconductor packages to the vision inspection apparatus, so waiting time and transfer time for the semiconductor packages can be reduced. Thus, the embodiments can significantly reduce the waiting time and time delay during the process of the handler system.

In addition, the vision inspection apparatus is installed across the moving route of the pickers and moves into the vision inspection area positioned below the pickers so as to inspect the semiconductor packages, so the vision inspection apparatus can inspect the semiconductor packages with maximum photographing capacity. Accordingly, the embodiments can significantly improve the speed of the vision inspection for the semiconductor packages for unit per hour (UPH), without requiring a plurality of expensive vision inspection apparatuses.

Furthermore, since the semiconductor package transfer mechanism according to one embodiment includes a pair of package transfer units capable of alternately transferring the semiconductor packages while being operated individually from each other, the semiconductor packages can be rapidly transferred to the vision inspection apparatus.

Accordingly, the semiconductor package transfer mechanism and the semiconductor package transfer method of the embodiments can effectively perform transfer work, pickup work, and vision inspection work for the semiconductor packages, so the package processing speed of the semiconductor package handler system for UPH can be significantly improved.

While this invention has been described in connection with certain embodiments, it is to be understood that the invention is not limited to the disclosed embodiments and the drawings, but, on the contrary, it is intended to cover various modifications and variations within the spirit and scope of the appended claims.

What is claimed is:

1. A semiconductor package transfer system comprising:
a plurality of pickup units operable independently of one another, each of the pickup units being configured to move along a respective one of a plurality of first paths; and
a vision inspection apparatus movable along a second path, the second path intersecting with the plurality of first paths, the vision inspection apparatus being configured to simultaneously inspect a predetermined number of workpieces arranged in a predetermined pattern, the predetermined number being substantially the maximum inspection capacity of the vision inspection apparatus,
wherein each of the pickup units is configured to transport the predetermined number of workpieces in the predetermined pattern to and from the vision inspection apparatus.

2. The system of claim 1, wherein the predetermined pattern comprises a matrix pattern comprising a plurality of rows and a plurality of columns, and wherein each of the rows comprises a first number of workpieces, and each of the columns comprises a second number of workpieces.

3. The system of claim 2, wherein the first number is the same as the second number.

4. The system of claim 2, wherein the first number is different from the second number.

5. The system of claim 2, wherein the predetermined pattern further comprises another row and/or another column, wherein the other row has a third number of workpieces, and the other column has a fourth number of workpieces, and wherein the third number is different from the first number, and the fourth number is different from the second number.

6. The system of claim 1, wherein the plurality of first paths extend substantially parallel to one another in a first direction, and wherein the second path extends in a second direction substantially perpendicular to the first direction.

7. The system of claim 6, wherein the vision inspection apparatus is configured to inspect first workpieces when positioned at a first intersection between the second path and one of the plurality of first paths.

8. The system of claim 7, wherein the vision inspection apparatus is configured to move to a second intersection between the second path and another of the plurality of first paths after inspecting the first workpieces, and wherein the vision inspection apparatus is configured to inspect second workpieces at the second intersection.

9. The system of claim 8, wherein one of the pickup units is configured to transport the second workpieces to the second intersection.

10. The system of claim 9, wherein the one of the pickup units is configured to transport the second workpieces to the second intersection such that the workpieces are ready for inspection before the inspection apparatus reaches the second intersection.

11. The system of claim 6, further comprising at least one first transfer unit and at least one second transfer unit, wherein the at least one first transfer unit is configured to transport the workpieces from an immediately previous processing location to a position which allows at least one of the pickup units to pick up the workpieces, and wherein the at least one second transfer unit is configured to transport the workpieces to an immediately subsequent processing location from a position which allows at least one of the pickup units to unload the workpieces.

12. The system of claim 11, wherein the at least. one first transfer unit is configured to travel along a third path, wherein the third path extends substantially parallel to the second path and substantially perpendicular to the plurality of first paths, and wherein the third path intersects with the plurality of first paths.

13. The system of claim 12, wherein the at least one second transfer unit is configured to travel along a fourth path, wherein the fourth path extends substantially parallel to the second path and substantially perpendicular to the plurality of first paths, and wherein the fourth path intersects with the plurality of first paths.

14. The system of claim 13, wherein the third path is positioned between the second path and the fourth path.

15. The system of claim 13, wherein the second path is positioned between the third path and the fourth path.

16. The system of claim 13, wherein the fourth path is positioned between the second path and the third path.

17. The system of claim 11, wherein the system comprises at least two shafts extending parallel to one another in one direction and at least two first transfer units, wherein each of the first transfer units comprises a moving frame movable along one of the shafts, and a turntable including a loading groove part on which the workpieces are loaded and an extra space part, wherein the loading groove part and the extra space part are alternately aligned, and wherein the first transfer units are operated independently of one another so as to alternately transfer the workpieces to and from the vision inspection apparatus.

18. The system of claim 11, wherein the at least one first transfer unit is configured to carry a multiple of the predetermined number of workpieces.

19. A method of transferring semiconductor packages, the method comprising:
providing a vision inspection apparatus configured to simultaneously inspect a predetermined number of workpieces arranged in a predetermined pattern, the predetermined number being substantially the maximum inspection capacity of the vision inspection device;
transporting the predetermined number of first workpieces in the predetermined pattern to a first position; and
moving the vision inspection apparatus to the first position; and
simultaneously inspecting the predetermined number of first workpieces using the vision inspection device.

20. The method of claim 19, further comprising:
transporting the predetermined number of second workpieces in the predetermined pattern to a second position;
moving the vision inspection apparatus to the second position after inspecting the first workpieces; and
simultaneously inspecting the predetermined number of second workpieces at the second position using the vision inspection device.
